(19) United States
(12) Patent Application Publication
(10) Pub. No.: US 2008/0136660 A1
(43) Pub. Date: Jun. 12, 2008

(54) Remote Controller for Patterned Flashing Lights on a Vehicle

(76) Inventor: John J. Bailey, Lincroft, NJ (US)

Correspondence Address: Glen M. Diehl;DIEHL SERVILLA LLC, Suite 110, 77 Brant Ave., Clark, NJ, 07066, US

(21) Appl. No.: 11/551,902

(22) Filed: Oct. 23, 2006

(51) Int. Cl. G09F 9/33

(52) U.S. Cl. 340/815.45

(57) ABSTRACT

A wirelessly controlled system for animating lighting on a vehicle is disclosed. The lighting system includes neon lights adapted for animation. A wireless controller for wirelessly controlling the lighting system is also disclosed. The wireless controller can initiate, terminate and control different modes of the lighting system and includes a display providing a status of the lighting system.

### BACKGROUND OF THE INVENTION

The present invention relates to accessory lighting and other lighting on vehicles and more specifically to the remote control of such lighting in patterns, programmable and otherwise.

Accessorizing the interior and exterior of cars with lights is popular in a significant market segment of car owners. Buyers of accessory lighting recognize the quality of the lighting, the location of the lighting fixtures on the car, colors and flashing patterns as important differentiators. The lighting elements may include neon, LEDs, electroluminescent (EL), fluorescent, incandescent and phosphorescent components. In general, the purpose for the addition of additional lights is to outline certain shapes of the vehicle, accent certain features of the vehicle or, for instance, illuminate parts of the vehicle, such as under the vehicle, that will create innovative lighting and shadowing effects especially at night.

Currently, the lighting effects of accessory lighting systems are generally activated from inside a vehicle. In this case, one has to physically push a button or turn on a switch inside a vehicle. One cannot direct the sequencing of the lighting or select a preprogrammed or un-programmed animation of the lights from outside the vehicle.

Accordingly, methods and apparatus to switch on remotely lighting effects on a vehicle, and to control patterns and lighting effects, are needed.

### SUMMARY OF THE INVENTION

In accordance with one aspect of the present invention, a method and apparatus for wirelessly controlling a decorative lighting system is provided. One aspect of the apparatus of the present invention controls a light or a lighting element on a vehicle. The apparatus includes a controller adapted to be connected to the vehicle and to the light so as to be able to control the operation of the light and a remote control device that can communicate wirelessly with the controller to cause the controller to cause the light to undergo a plurality of on/off cycles.

In accordance with another aspect of the present invention, the light undergoes a plurality of on/off cycles in a pattern. The pattern can be pre-programmed or controlled by an operator. The apparatus of the present invention can also be used to control a plurality of lights to undergo on/off cycles. In this case, a pattern is created remotely using a plurality of lights. The program for animating the light or lights in a pattern can be stored in the remote control, in the controller, in a lighting element or can be programmed into the remote control.

In accordance with another aspect of the present invention, the control device is a remote control that includes a display that indicates that the lights are operational. The control device's display can indicate the pattern that the lights operate under.

In accordance with a further aspect of the present invention, the remote control device includes a display that indicates a status of one or more controls on the control device. Thus, the status of one or more of the functions enabled by the controller and activated remotely can be displayed on the remote control device.

The present invention can be used on any type of a vehicle, including a car, truck, motorcycle, bicycle, skateboard, roller skates, or the like. The lights used in the present invention are preferably accessory lights, but can be any element on a vehicle that emits light. These lights include neon lights, EL wires, EL plates, LEDs, LED strips, LED fog lights, LED license plate frames and light bulbs. Any other type of light can be used.

In accordance with another aspect of the present invention, the remote control device can be a key fob. The remote control device can be any other type of structure as well.

In accordance with a further aspect of the present invention, lights are controlled by the remote control device. The remote control device includes a display that indicates, in real time, the operation of the lights. It also enables an operator to turn a light or a lighting element on or off. It also allows animation of lights. For example, one can animate a group of neon tubes by transmitting a series of on/off cycles from the wireless remote. The lights can also be controlled so that they beat with music being played.

In accordance with yet another aspect of the present invention, the controller can operate in a plurality of animation modes to cycle the decorative lights in a plurality of patterns. The controller can store the plurality of animation modes or the remote control device can store the plurality of animation modes and transmit a selected code to the controller to control the lights. A tube or lighting element can also store the animation modes.

In accordance with a further aspect of the present invention, the lights can be controlled to allow them to match the beat of music being played.

One aspect of the present invention, therefore, provides a wirelessly controlled vehicle lighting system adapted for animation. A multitude of lighting elements can be controlled and animated from a wirelessly controlled, hand-held device that can be used outside a vehicle.

### DESCRIPTION OF THE DRAWINGS

FIG. 1 illustrates a system in accordance with one aspect of the present invention.

FIG. 2 illustrates a wirelessly controlled lighting system on a car.

FIG. 3 is a diagram of a wirelessly controlled controller in accordance with one aspect of the present invention.

FIGS. 4 to 6 illustrate a wireless remote controller in accordance with an aspect of the present invention.

FIGS. 7 and 8 illustrate a display and controls on a wireless remote controller in accordance with another aspect of the present invention.

FIG. 9 is another diagram of a wirelessly controlled controller.

FIG. 10 illustrates another embodiment of the present invention.

### DESCRIPTION OF A PREFERRED EMBODIMENT

Different lights are available on the market for lighting the interior and exterior of a vehicle and for accentuating different aspects of the shape of a vehicle or its components. For instance, one can accentuate wheels; one can also accentuate license plates, wheel wells, car bumpers, grilles, door handles, trim panels, washer nozzles and wind-shield wipers. Undercar lighting kits that are attached under a vehicle are also available. Furthermore, the lights attached to cars may come in different shapes, fixtures, colors, sizes and type of lights such as fluorescent, xenon, phosphorescent, LED, neon and incandescent lights and can include EL Wire and EL Plate, Neon Tubes, Neon Tubes with built-in transformer, LED Strips, LED Fog Lights, LED Tubes, LED Scanners, Xenon Lights, Xenon strobe lights and light bulbs. The present invention is operable with any of these types of lights.

To enhance the artistic effect of the attached lighting, one can switch on/off different lights at different moments with different sequences or patterns. The on/off flashing of lights programmed by a pattern is known as animation. Neon lights on vehicles are generally just switched on and stay on and are not known to be used for animation by a preprogrammed sequence.

Accessory lighting products may come with preprogrammed on/off pattern controllers. In accordance with one aspect of the present invention, a wireless remote control device is provided that remotely controls a light or a lighting system located on the inside or outside of a vehicle. The remote control device switches lights or their elements on or off, according to a programmed or determined pattern in a novel approach.

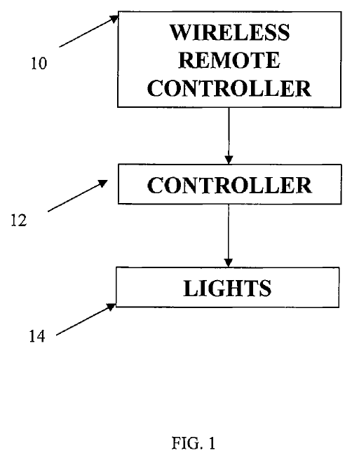

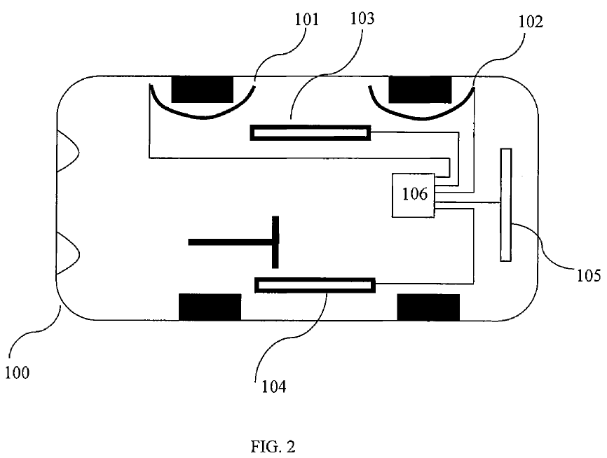

FIG. 1 illustrates a system in accordance with one aspect of the present invention. A wireless remote control 10 communicates wirelessly with a controller 12 to control lights 14. The lights are mounted underneath a vehicle, such as a car, as illustrated in FIG. 2. The wireless remote control 10 can transmit a signal to the controller 12 to control a single light 14 and cause the light to cycle through on/off states to create a pattern. The remote control 10 can also transmit a signal to the controller 12 to control a plurality of lights 14 to cycle through on/off states to create a pattern. The remote control 10 can transmit a signal to the controller 12 to vary the on and off times of each of the lights 14 and can vary the intensity of each of the lights 14 to create the patterns or animation of the decorative lights.

In accordance with one aspect of the invention, the remote control device 10 that can transmit signals to control a controller 12 to cause lights 14 to be turned on and off can be sold. In accordance with a further aspect of the invention, the remote control device 10 and the controller 12 can be packaged together and sold as a unit. In accordance with another aspect of the invention, the remote control device 10, the controller 12 and the lights 14 can be packaged together and sold as a unit. Pre-programmed patterns can be stored in either the remote control device 10, the controller 12, or the lights 14.

FIG. 2 is a diagram of a vehicle, in this case a car, according to one aspect of the present invention. The front 100 of the car is indicated. The car has a controller 106, which is remotely and wirelessly controlled by a remote control 10. The remote control 10 can be provided as a fob, or as any other structure. The car has attached to it several lighting components. For example, lighting systems 101 and 102 are wheel well lighting systems. Also shown, connected to a controller 106, are two under car lights 103 and 104. These lights may be neon lights, or they can also be any of the previously mentioned types of lights. Also shown, connected to the controller 106, is a light 104 which may be a string of LEDs. The lights can also be strobe lights. The number of connected lighting systems may vary and may be smaller or larger. For example, the number of lights can be one or it can be a plurality of lights as shown in FIG. 2. Each of the lights shown in FIG. 1 are controlled by the controller 106, as previously described.

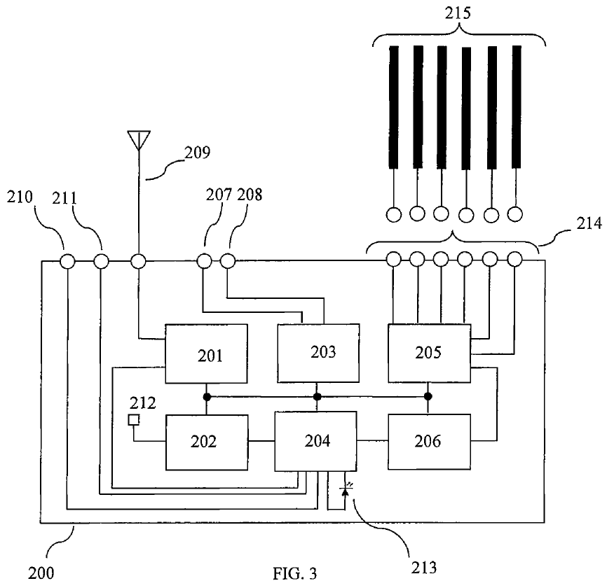

A block diagram of a wirelessly controlled lighting system controller, in accordance with one aspect of the present invention is provided in FIG. 3. The controller 200 can include the following units: a receiver 201, a music interface 202, a power regulator 203, a CPU 204, an overload protection circuit 206 which can protect all and individual outputs for overload and a driver 205. The receiver 201 is connected to an antenna 209 when the receiver is a radio receiver. The receiver 201 also processes the received signal into a signal that can be used by the other units when required. All units can be powered from an electrical power source connected to inputs 207 and 208. Such a power source can, for example, be a 12 Volt car battery. In order to provide the correct power and/or voltage, the power provided by an external source is conditioned by a power regulator 203. The illustrated connections between the units provide power and signal connections. The driver 205 provides the power for a plurality of lights 215 which are connected to a plurality of outputs 214. An individual output may be dedicated to a certain type of lighting having specific power or voltage requirements. The specific voltages are provided to an output by the driver 205.

Protection to the lighting system and the controller in case of overload is provided by an overload protection circuit 206. The music interface unit 202 can receive its input from the CPU 204 or from a sound source 212. The music interface processes the sound to generate, for instance, a switching pattern derived from sound levels, and which may have been filtered according to the frequency components in the sound. The music interface unit 202 can be connected to a separately provided speaker that becomes part of the animation program presented under control of the controller 200. The CPU 204 provides the control signals to be provided to the outputs 214 based on its input from the receiver, music interface and/or overload protection circuit. The controller 200, as was shown in FIG. 1, is located inside the vehicle. This means it may be located inside the passenger space, for instance under the dashboard or under a rear seat. It may also be located in a trunk, or under the engine hood.

The controller 200 preferably provides flashing outputs of 12 and 24 volts to light up different types of lights that work under 12 and 24 volts.

One aspect of the controller provides a measure of security and safety. For instance, one may enable some or all of the lighting functions only when a door of the vehicle is opened and may be derived from the courtesy light switch or when a key is in the vehicle's ignition. The fulfillment of these or other conditions can be provided on separate inputs. For example an input 210 provides a trigger input to the CPU 204 that a door is open. An input 211 may provide the input to the CPU that the key is in the ignition lock. LED 213 is a power indicator that lights up when the system is on.

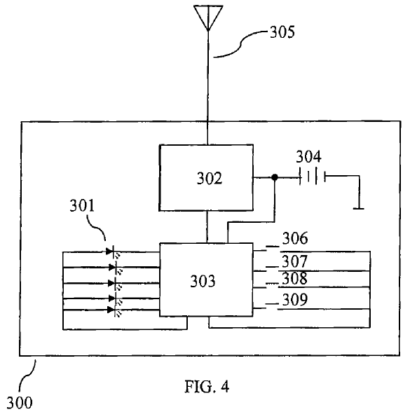

In FIG. 4, a diagram of a wireless remote controller for the lighting system controller is provided. The wireless remote control 300 comprises a transmitter 302 for transmitting signals to the controller located in the vehicle, an antenna 305, an encoder 303, a display 301 and a control pad comprising controls 306, 307, 308 and 309. A power source 304, for example a dry cell battery, is also included in the remote control.

The control pad in a first embodiment has four controls which may be push buttons 306 to 309. It should be clear that embodiments of a control pad, with more or less controls, such as buttons are, possible and are fully contemplated. Different types of controls are also contemplated. For example sliding controls, touch screen controls, rotating switches and voice recognition controls are possible and are contemplated. The individual controls 306, 307, 308 and 309 are connected to an encoder 303 which determines the appropriate control in accordance with the status of the controls 306 to 309.

Activating a control will enable the encoder to generate a code representing a specific command which will be processed by the transmitter and provided as a transmittable signal, for instance, to the antenna 305 if the signal is a radio signal. Such a signal may be received by the lighting controller via its antenna 209 and provided to the receiver 201. The receiver 201 will demodulate and process the signal as necessary and provide it as a message or code to the CPU 204. Based on the received code or message, the CPU 204 will execute preprogrammed instructions that will enable one or more desired actions.

For instance one code enabled by a control in 300 may switch devices on or off in the vehicle with controller 200. Another code may select and activate some or all components of the lighting system and a sound system in the vehicle. A further code may activate a certain light pattern to be provided via the driver 206 and the outputs 214 to the lights 215.

In a preferred embodiment the wireless remote control 300 for the lighting controller 200 is part of a key FOB which is commonly used to remotely unlock and lock the locks on a car. It should be clear that because a key FOB should fit in a person's pocket or purse that its size is limited. This also means, in general, that the number of controls on the control pad of the key FOB has to be limited. This can be addressed by using, for instance, a limited number of buttons but wherein one button has a ‘mode’ function which will assign different commands to other buttons of the key FOB. The range of commands per button can also be extended by providing a ‘step-through’ type of command. This means that every time a control is activated, for instance, by pushing a button, one of a series of commands is provided. The series of commands under one control is limited. Once the end of the series is reached, the series of commands may start over again. A command may be activated by not stepping to another command within a predetermined time. Alternatively, a command may be activated or by activating another control after one of a series of commands has been activated, for example, after a first mode command has been selected.

In accordance with another aspect of the present invention and referring to FIGS. 3 and 4, various patterns of lighting the decorative lights under a vehicle are enabled by a controller 200 under control of a remote control 300. For example, a plurality of different animation patterns, wherein the lights under a car are sequentially turned on and off in a pattern are selected by the controls 306 to 309. In accordance with one aspect of the present invention, the pattern can be stored on the controller 200 in the memory of the CPU 204. Alternatively, the pattern of the animation can be transmitted from the remote control 300 to the controller 200.

As previously noted, the animation pattern can include music. The music provided can either be stored in the controller 200 or can be provided from an external source.

The remote controller, in one embodiment of the present invention, also has a display 301 that can show which function is being activated, which function has been activated and, for instance, if a function is being increased or decreased. The display 301 can be one or more LEDs or can be a small screen formed, for example, by an LCD.

In one embodiment of the present invention, the remote controller has the following settings and capabilities:
0. a control command to switch the complete system on or off;
1. a control command for selecting one of multiple control modes, providing different command capabilities to the controls of the remote control such as: all on, music mode, demo mode and preprogrammed pattern mode;
2. a control command able to switch all devices controlled by the controller on or off; controlling one neon device;
3. a control command able to selectively switch any of the devices controlled by the controller on or off, including at least one neon device;
4. a control command to select a music mode, wherein all lighting devices that are switched on are activated to animate to the beat of the music or to the signal as provided by the music interface;
5. a control command to select the mode for preprogrammed, selectable flashing patterns;
6. a control command to select and activate within the mode for preprogrammed patterns any of the patterns;
7. a control command ‘door open input’ which, if activated, will activate all connected and controlled devices when the vehicle door is open;
8. a control command that increases the sound sensitivity in the music mode;
9. a control command that decreases the sound sensitivity in the music mode;
10. a control command that increases a speed of a flash or ‘chase’ in the preprogrammed patterns mode; and
11. a control command that decreases a speed of a flash or ‘chase’ in the preprogrammed patterns mode.

Other embodiments of the remote control device can be provided in accordance with further aspects of the present invention.

Thus, in one aspect of the present invention, a control command may be achieved by the activation or pushing of a button on a wireless controller. Activating a control such as a button may provide a command depending on the mode that the remote controller is in. Accordingly, a specific control command would be active after activating one or more other command controls.

FIG. 4 shows a diagram of a remote control device comprising four controls which can be activated: 306, 307, 308 and 309. Button 306 is an on/off switch for the controller 200. Control 309 provides the mode control. Control 307 is an increase control (increasing in a series of possibilities, such as sensitivity or speed) and control 308 is a decrease control (decreasing in a series of possibilities). What aspect is increased or decreased depends on the mode. The mode and the status of selected controls and devices can be displayed on display 301.

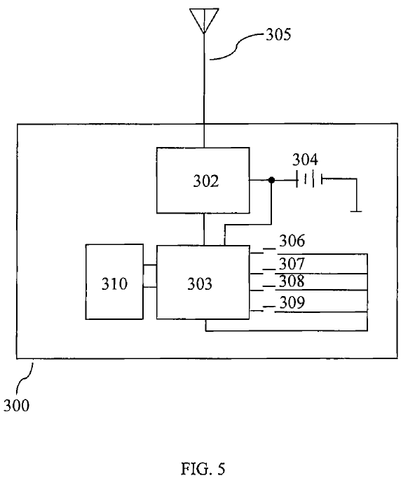

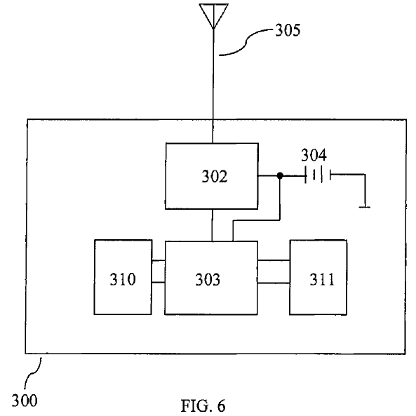

Different embodiments of the wireless remote control are possible and are fully contemplated as an aspect of the present invention. One may replace the display 301 of individual elements such as LEDs in FIG. 4 by a small screen 310 such as an LCD as shown schematically in FIG. 5. In that case, the encoder 303 may need to become more powerful and may, for instance, be a processor with programmable memory. The control pad 306 with 4 controls may also be replaced by a more elaborate control pad 311 as shown schematically in FIG. 6 with more and different control capabilities such as a touch pad and sliders.

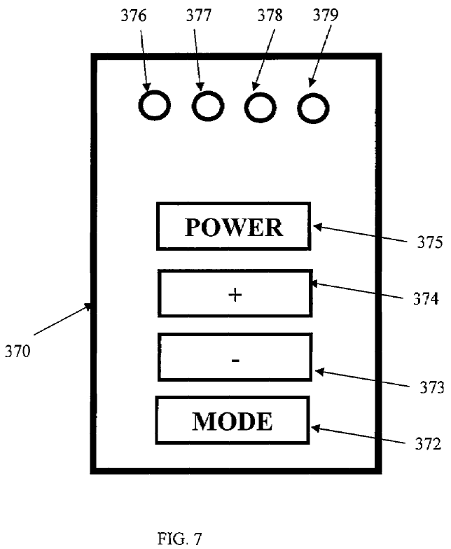

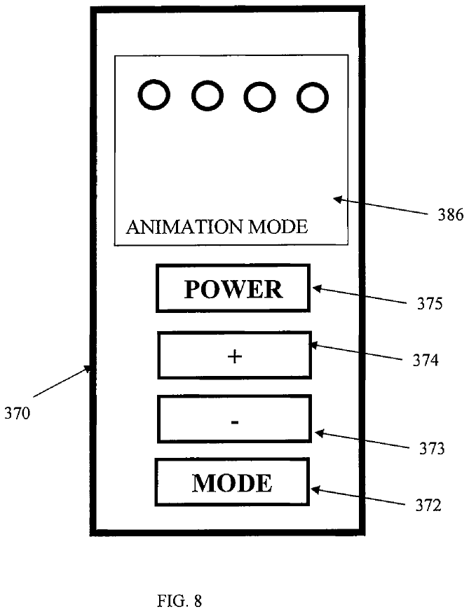

FIGS. 7 and 8 illustrate external views of a wireless remote control 370, which is the device 10 in FIG. 1. Four buttons 372 to 375 provide the previously described controls. In FIG. 7, four LEDs 376 to 379 provide a real time display of the light show being displayed on lights in a vehicle. Thus, the LEDs 376 to 379 light up when four lights on a vehicle light up. The LEDs 376 to 379 can be controlled by the remote control device 370 with signals derived from the commands being sent to the controller 12 to control the lights 14. Alternatively, the remote control device 370 can receive signals back from the controller 12 as the controller 12 causes the lights 14 to be turned on and off. Either way, the LEDs 376 to 379 provide a real time display of the animation of the lights 14 being turned on and off to be displayed on the remote control device 370. In FIG. 8, an LCD display 386 is provided on the wireless remote control 370. Four areas, as indicated on the LCD display 386, are lit up in accordance with the pattern of animating the lights 14 to provide a real time display of the pattern of lighting the lights 14.

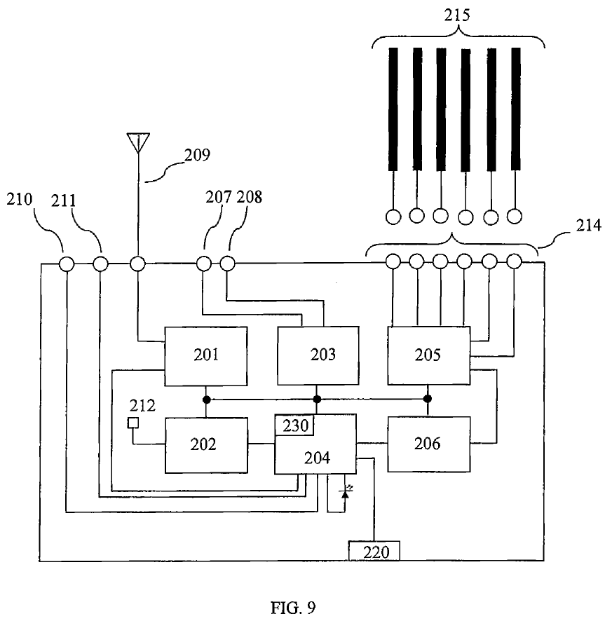

One may also expand the controller, for instance, with an external port 220 as shown in FIG. 9 and a programmable memory 230. This enables adding or replacing preprogrammed patterns to the controller. It is also contemplated making receiver 201 and transmitter 302 both transceivers, allowing the controller 200 to provide current and updated status information to the remote control 300. It would also enable programming the CPU and add instructions to 230 via the remote controller 300.

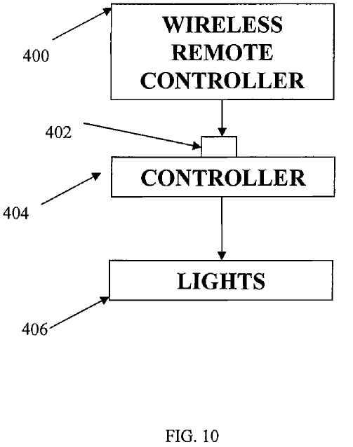

Referring to FIG. 10, a wireless remote control 400 and a wireless adapter 402 are provided in a package. The wireless adapter 402, when removed from the package, is interfaced with an existing controller 404 that controls lights 406. The wireless adapter 402 can receive control signals wirelessly sent by the remote control 400 to control the lights 406 through the controller 404, and provide the control signals to the controller 404. Pre-programmed patterns for turning the lights 406 on and off in a certain pattern can be stored in the wireless remote control 400.

Of course, all of the components in FIG. 10 can be provided in a package or any subset of the components can be provided in the package.

When a light is mentioned, it is understood that the term includes any type of light or any other element that can emit light in anyway.

While there have been shown, described and pointed out fundamental novel features of the invention as applied to preferred embodiments thereof, it will be understood that various omissions and substitutions and changes in the form and details of the device illustrated and in its operation may be made by those skilled in the art without departing from the spirit of the invention. It is the intention, therefore, to be limited only as indicated by the scope of the claims appended hereto.

1. Apparatus for controlling a light on a vehicle, comprising:
a controller adapted to be connected to the vehicle and to the light so as to be able to control the operation of the light; and
a remote control device that can communicate wirelessly with the controller to cause the controller to cause the light to undergo a plurality of on/off cycles.

2. The apparatus of claim 1, wherein the light undergoes a plurality of on/off cycles in a pattern.

3. The apparatus of claim 1 for controlling one or more additional lights on the vehicle, wherein the controller is connected to the one or more lights so as to be able to control the operation of the one or more lights and the control device can communicate wirelessly with the controller to cause the controller to cause the one or more lights to undergo a plurality of on/off cylces

4. The apparatus of claim 3, wherein the light and the one or more lights undergo a plurality of on/off cycles in a pattern.

5. The apparatus of claim 1, wherein the control device includes a display that indicates that the light is operational.

6. The apparatus of claim 2, wherein the control device includes a display that indicates the pattern.

7. The apparatus of claim 3, wherein the control device includes a display that indicates that the light and the one or more lights are operational.

8. The apparatus of claim 4, wherein the control device includes a display that indicates the pattern.

9. The apparatus of claim 1, wherein the control device includes a display that indicates a status of one or more controls on the control device.

10. The apparatus of claim 8, wherein the control device includes a display that indicates a status of one or more controls on the control device.

11. The apparatus of claim 4, wherein the vehicle is a car.

12. The apparatus of claim 1, wherein the one or more lights and the light are selected from the group consisting of neon lights, EL wires, EL plates, LEDs, LED strips, LED fog lights, and light bulbs.

13. The apparatus of claim 1, wherein the controller can selectively control different types of lights selected from the group consisting of neon lights, EL wires, EL plates, LEDs, LED strips, LED fog lights, license plate frames and light bulbs.

14. The apparatus of claim 3, wherein the control device is a key fob.

15. The apparatus of claim 2, wherein the controller can operate in a plurality of animation modes to cycle the one or more lights and the light in a plurality of patterns.

16. The apparatus of claim 4, wherein the controller can operate in a plurality of animation modes to cycle the one or more lights and the light in a plurality of patterns.

17. The apparatus of claim 16, wherein the controller stores the plurality of animation modes.

18. The apparatus of claim 16, wherein the remote control device stores the plurality of animation modes.

19. The apparatus of claim 2, comprising the controller causing music to be played by a speaker under control of the control device.

20. The apparatus of claim 1, further comprising one or more lights.

21. A package to interface to a controller that turns one or lights on a vehicle on and off, comprising:
a remote control device that can wirelessly transmit a control signal to allow the controller to control the one or more lights on the vehicle; and
a wireless circuit that can be interfaces with the controller and that can receive the control signal and supply the control signal to the controller.

22. The package of claim 21, wherein the remote control device includes a display that can illustrate a pattern that the one or more lights
